(19) United States
(12) Patent Application Publication
(10) Pub. No.: US 2019/0020302 A1
(43) Pub. Date: Jan. 17, 2019

(54) HORIZONTAL SINGLE-AXIS TRACKING PHOTOVOLTAIC SUPPORT WITH DOUBLE-SIDED POWER GENERATION

(71) Applicant: HANGZHOU PINNET TECHNOLOGIES CO., LTD., Hangzhou (CN)

(72) Inventors: Wenyong CHEN, Hangzhou (CN); Zhongtang LIANG, Hangzhou (CN); Long WANG, Hangzhou (CN)

(73) Assignee: HANGZHOU PINNET TECHNOLOGIES CO., LTD., Hangzhou (CN)

(21) Appl. No.: 15/741,293

(22) PCT Filed: Apr. 28, 2017
(86) PCT No.: PCT/CN2017/082533

§ 371 Date: Jan. 2, 2018

(30) Foreign Application Priority Data
Mar. 7, 2017 (CN) 201720213782.6

(51) Int. Cl. H02S 20/32; H02S 40/22; F24S 30/425; F24S 50/20

(52) U.S. Cl. CPC H02S 20/32; H02S 40/22; F24S 2030/11; F24S 50/20; F24S 30/425

(57) ABSTRACT

The present invention provides a horizontal single-axis tracking photovoltaic support with double-sided power generation, suitable for installing a double-sided PV module with a toward-sun light absorption surface and a backward-sun light absorption surface, including: an upright post and a torque tube disposed on the upright post, the torque tube capable of being rotated around the upright post under the action of a driving device, a plurality of groups of crossbeams are disposed along a lengthwise direction of the torque tube, and the double-sided PV module is disposed on each group of the crossbeams, a light-reflecting-panel support is disposed at the torque tube, and a light-reflecting panel is disposed on the light-reflecting-panel support. The light-reflecting panel reflects sunlight onto the backward-sun light absorption surface, and an angle α between the plane where the light-reflecting panel is located and the plane where the double-sided PV module is located is an acute angle.

### BACKGROUND OF THE INVENTION

### Field of the Invention

The present invention relates to a photovoltaic (PV) module tracking support and, more particularly, to a horizontal single-axis tracking photovoltaic support with double-sided power generation, which belongs to the technical field of PV module installation.

### Description of the Related Art

A double-sided photovoltaic (PV) module can generate electric energy by absorbing solar energy through the front and back sides thereof. Compared with an ordinary module, the double-sided PV module increases the power generation capability of the back surface, making the power generation capability of the double-sided PV module increased compared with the ordinary module. However, the sunlight cannot effectively reach the backward-sun surface of the double-sided PV module, as a result of which the power generation capacity of the double-sided PV module cannot be maximized.

The double-sided PV module reflects the sunlight to the back surface of the double-sided PV module mainly by diffuse reflection, and the sunlight absorbed by the back surface is less, resulting in less power generation of the double-sided PV module. In order to increase the light intensity on the back surface of the double glass PV module, people have made all sorts of attempts. For example, a Chinese patent application document with publication number CN106339009 and entitled “Double-sided Glass Solar Cell Panel Tracking Support” discloses a double-sided glass solar panel tracking support. By disposing a light-reflecting panel under the photovoltaic module to increase the light irradiation on the back surface of the double glass PV module, the photoelectric conversion efficiency of the double glass PV module is improved to a certain extent. However, the light-reflecting panel and the double glass PV module are disposed in parallel, and the light-reflecting panel is located directly under the double glass PV module. The light-reflecting panel is partially covered, as a result of which only part of the light is reflected to the back surface of the double glass PV module by the light-reflecting panel, and the added light irradiation is limited; in addition, during the installation, the double-glass solar panel and the light-reflecting panel needs to be separated by a relatively large distance so as to achieve a certain extent of sunlight reflection. Thus the space occupation is increased and the installation height of the double-sided glass panel needs to be increased, which reduces the installation stability of the double-sided glass solar panel.

### BRIEF SUMMARY OF THE INVENTION

In order to overcome the shortcomings of the prior art, the present invention provides a horizontal single-axis tracking photovoltaic support with double-sided power generation, which effectively increases the light intensity on the backward-sun surface of the double-sided photovoltaic (PV) module, improves the photoelectric conversion efficiency of the double glass PV module, and ensures the installation stability and convenience at the same time.

To achieve the above objectives, the present invention adopts the following technical solution:

A horizontal single-axis tracking photovoltaic support with double-sided power generation, suitable for installing a double-sided PV module with a toward-sun light absorption surface and a backward-sun light absorption surface, includes: an upright post and a torque tube disposed on the upright post, the torque tube capable of being rotated around the upright post under the action of a driving device, a plurality of groups of crossbeams disposed along a lengthwise direction of the torque tube, and the double-sided PV module disposed on each group of the crossbeams, a light-reflecting-panel support disposed at the torque tube, and a light-reflecting panel disposed on the light-reflecting-panel support. The light-reflecting panel reflects sunlight onto the backward-sun light absorption surface, and an angle α between the plane where the light-reflecting panel is located and the plane where the double-sided PV module is located is an acute angle.

In the invention, both the double-sided PV module and the light-reflecting panel are disposed at the torque tube, and the torque tube can be rotated round the upright post under the action of the driving device, such that the PV module and the light-reflecting panel can track the sun's rays synchronously, thereby ensuring that the sun's rays can be reflected to the back surface of the double-sided PV module and increasing the power generation of the back surface of the double-sided PV module.

Further, the light-reflecting-panel support may be substantially W-shaped, and the light-reflecting panels may be disposed on two outer side portions of the light-reflecting-panel support, making the light-reflecting panel disposed symmetrically relative to the torque tube, that is, on both sides of the PV module, in order to better increase the light irradiation on the back surface of the PV module. The structure is simple, and the strength is good.

Further, the light-reflecting-panel support may include a support main body and two outer side portions connected with the support main body, the support main body may be fixedly connected with the torque tube, and two outer side portions may be rotatably connected with the support main body. When the torque tube is rotated under the action of the driving device, the support main body rotates with the torque tube thus to drive the light-reflecting-panel support and the light-reflecting panel to rotate, such that the light-reflecting panel tracks the sun's rays. The two outer side portions can rotatably connected with the support main body, which facilitates adjusting the angle of the two outer side portions, thereby making the light-reflecting panel have the best angle of reflection.

Further, by adjusting the angle of the light-reflecting panel, the light reflected on the outmost side of the light-reflecting panel can reach the outer side end of the backward-sun light absorption surface of the double-sided PV module, and the light reflected on the innermost side of the light-reflecting panel can reach the inner side end of the backward-sun light absorption surface of the double-sided PV module. In this way, the light-reflecting panel located on one side of the torque tube is responsible for the light reflection on the back side of the double-sided PV module, maximizing the utilization of the light reflection and making the light on the back surface of the module substantially uniform.

In one embodiment, the angle α between the plane where the light-reflecting panel is located and the plane where the double-sided PV module is located may range from 0° to 90°. The setting of this angle gives consideration to both the area of the light-reflecting panel and the efficiency of the light reflection.

Further, the driving device may be a servo motor, a cylinder, or a hydro-cylinder, and the torque tube may be driven to be rotated by a power output end of the driving device. The material is easy to acquire, the control is convenient, and the effect is good.

Further, a surface of the light-reflecting panel may be a flat surface, a convex surface, or a concave surface.

In summary, the horizontal single-axis tracking photovoltaic support with double-sided power generation of the present invention can effectively reflect the sun's rays to the backward-sun light absorption surface of the module, thereby improving the photoelectric conversion efficiency of the back surface of the module thus to improve the photoelectric conversion efficiency of the whole PV module; and at the same time, the installation stability of the double-sided PV module is ensured without increasing the installation height of the double-sided PV module

### BRIEF DESCRIPTION OF THE DRAWINGS

FIG. 1 is a front view of a support according to one embodiment of the present invention;

FIG. 2 is an irradiating and reflecting schematic diagram of the sunlight on a photovoltaic (PV) module according to one embodiment of the invention;

FIG. 3 is a right view of the support according to one embodiment of the invention;

FIG. 4 is a top view of the support according to one embodiment of the invention; and

FIG. 5 is a perspective view of the support according to one embodiment of the invention.

### FIGURE REFERENCE NUMERALS

1 double-sided PV module, 11 toward-sun light absorption surface, 12 backward-sun light absorption surface, 2 upright post, 3 torque tube, 4 driving device, 5 crossbeam, 6 light-reflecting-panel support, 61 support main body, 62 outer side portion, and 7 light-reflecting panel.

### DETAILED DESCRIPTION OF THE INVENTION

The above and other technical features and advantages of the present invention will be clearly and completely described combining with the accompanying drawings hereinafter. Apparently, the described embodiments are merely parts of the embodiments of the present invention instead of all the embodiments.

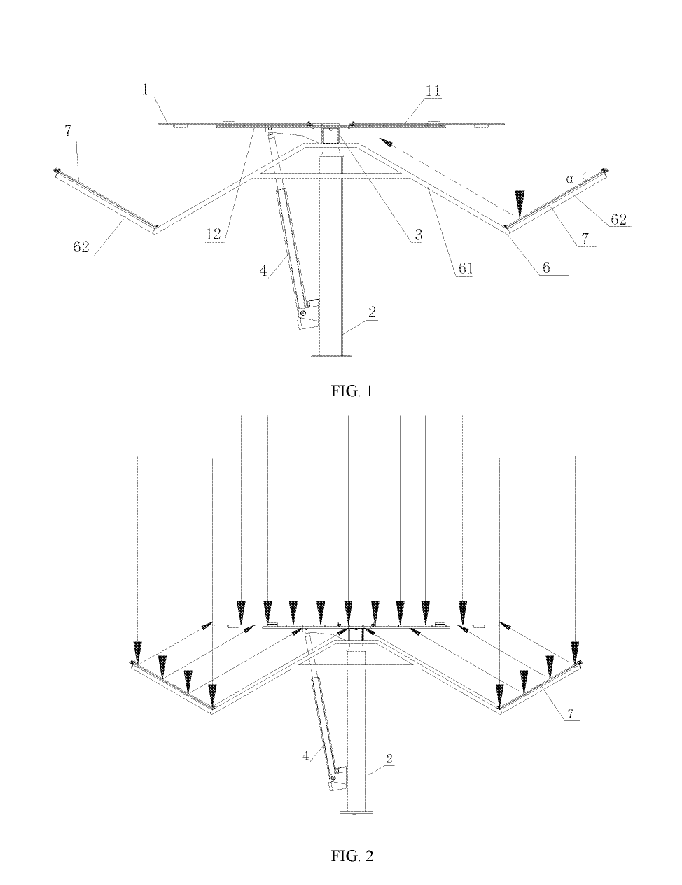

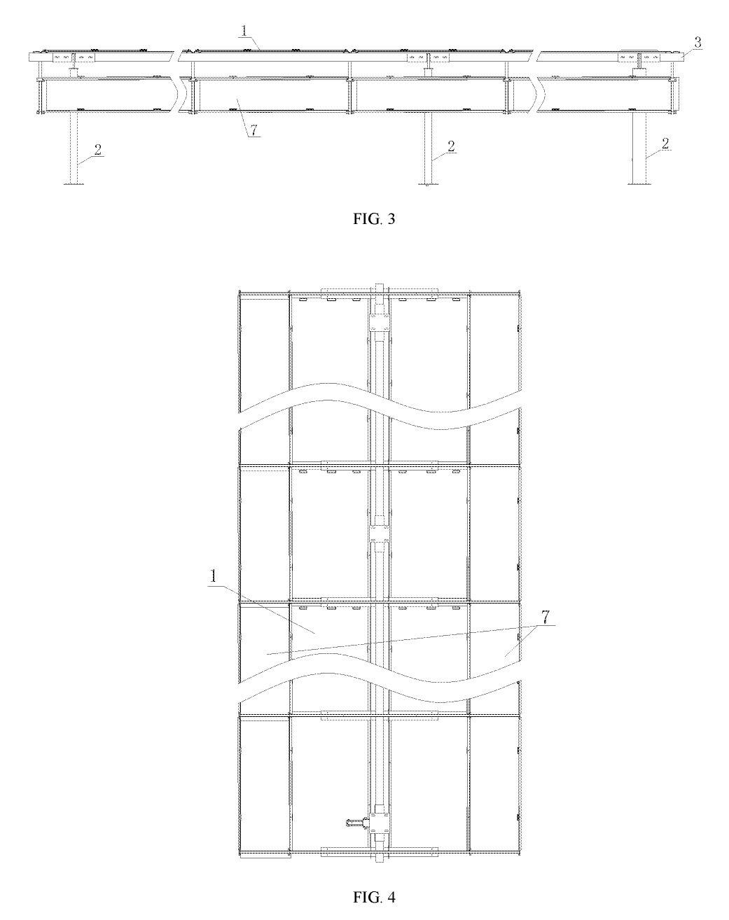

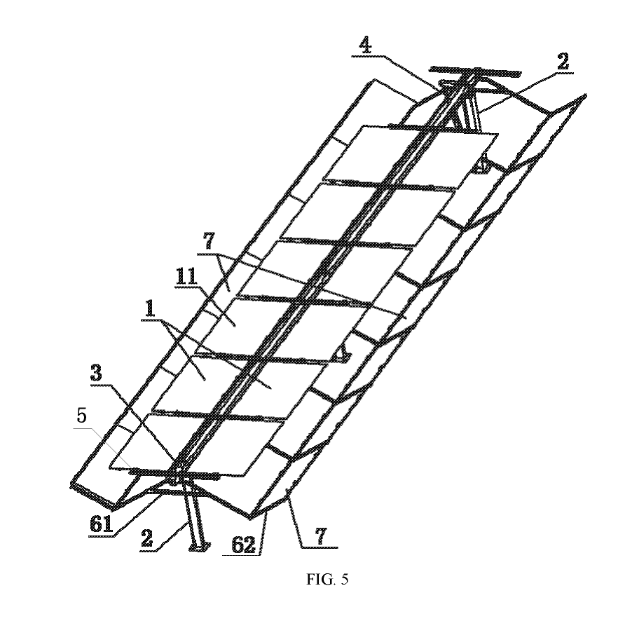

As shown in FIGS. 1-5, a horizontal single-axis tracking photovoltaic support with double-sided power generation in the present invention is suitable for a double-sided photovoltaic (PV) module 1. The double-sided PV module 1 has a toward-sun light absorption surface 11 and a backward-sun light absorption surface 12. The support according to the present invention includes an upright post 2 and a torque tube 3 disposed on the upright post 2, and the torque tube 3 can be rotated around the upright post 2 under the action of a driving device 4. Generally speaking, the upright posts are disposed in pairs, and a torque tube 3 is disposed on a pair of posts. A plurality of groups of crossbeams 5 are disposed along a lengthwise direction of the torque tube 3, and a double-sided photovoltaic module 1 is disposed on each group of the crossbeams. That the torque tube 3 is rotated around the upright post refers that the torque tube is rotated around the upright post in the lengthwise direction. As shown in FIG. 3, the number of the upright post and the number of the torque tube are not limited to those as shown in the figure.

A light-reflecting-panel support 6 is disposed at the torque tube 3, the light-reflecting-panel support 6 is disposed at both sides of the torque tube 3 symmetrically, and a light-reflecting panels 7 is disposed on the light-reflecting-panel support 6. An angle α between the plane where the light-reflecting panel is located and the plane where the double-sided PV module 1 is located is an acute angle. Herein, the side of the double-sided PV module 1 which is close to the torque tube 3 and the side of the light-reflecting panel 7 which is close to the torque tube 3 are defined as an inner side, and the side opposite to the inner side is an outer side.

As a specific way of implementation, the light-reflecting-panel support 6 is substantially W-shaped. The light-reflecting-panel support 6 includes a support main body 61 and two outer side portions 62 connected with the support main body 61. The support main body 61 is fixedly connected with the torque tube 3, and two outer side portions 62 can be rotatably connected with the support main body 61. The light-reflecting panels 7 are disposed on two outer side portions 62. Therefore, when the torque tube 3 is rotated under the action of the driving device 4, the support main body 61 rotates with the torque tube 3 to drive the two outer side portions 62 and the light-reflecting panels 7 disposed on the two outer side portions to rotate, thereby making the light-reflecting panels 7 and the double-sided PV modules track the sun's rays synchronously. Two outer side portions 62 can be rotatably connected with the support main body 61, which facilitates adjusting the angle of the two outer side portions, making the light-reflecting panels have the best angle of reflection.

As shown in FIG. 2, in order to obtain a better efficiency, by designing the curvature of the reflective surface of the light-reflecting panel, the length of the light-reflecting panel, and the angle between the light-reflecting panel and the double-sided PV module, the light reflected on the outmost side of the light-reflecting panel can reach the outer side end of the backward-sun light absorption surface of the double-sided PV module, and the light reflected on the innermost side of the light-reflecting panel can reach the inner side end of the backward-sun light absorption surface of the double-sided PV module, such that the utilization efficiency of the reflected light reaches the highest. The surface of the light-reflecting panel can be a flat surface, a convex surface, or a concave surface. In the present embodiment, the light-reflecting panel 7 is a reflective mirror surface. The double-sided PV modules 1 are disposed at both sides of the torque tube 3 along the lengthwise direction, such that the light-reflecting panel located on one side of the torque tube is responsible for the light reflection of the PV module at this side, maximizing the utilization of the light reflection and making the light on the back surface of the modules substantially uniform at the same time. In FIG. 2, the direction indicated by the arrow is the irradiation direction of the sunlight; because the support in the present invention is a tracking support, the tracking photovoltaic support can rotate the modules with the change of the position of the sun, such that the sunlight can always irradiate on the modules perpendicularly. Through this feature, the present application adds a reflection device on the tracking photovoltaic support. The reflection device and the modules simultaneously track the sun position and reflect the light to the back surface of the modules thus to increase the power generation on the back surface of the double-sided PV modules.

In the present embodiment, the angle α between the plane where the light-reflecting panel 7 is located and the plane where the double-sided PV module 1 is located ranges from 0° to 90°. The setting of this angle gives consideration to both the area of the light-reflecting panel and the efficiency of the light reflection.

As a specific way of implementation, the driving device 4 can be a servo motor, a cylinder, or a hydro-cylinder, and the torque tube 3 is driven to be rotated by a power output end of the driving device 4. The support installed with the PV modules is able to rotate through the drive of the driving device, achieving the object of tracking the sun's rays. This is the prior art of the tracking support, which will not be repeated here.

The present invention has following advantages:

The double-sided PV modules 1 and the light-reflecting panels 7 track the sun's rays synchronously, making both the front and back surface have relatively good light irradiation and increasing the power generation efficiency of the modules; the reflection device is installed obliquely, ensuring that the sun's rays are fully reflected to the backward-sun light absorption surface of the double-sided PV modules 1, increasing the power generation of the double-sided PV modules 1, achieving more power generation with less double-sided PV modules 1, and improving the power generation efficiency of the modules; at the same time, the installation height of the double-sided PV modules 1 is not increased; and the space utilization rate is high, and the land occupying is less.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A horizontal single-axis tracking photovoltaic (PV) support with double-sided power generation, suitable for installing a double-sided PV module (1) with a toward-sun light absorption surface (11) and a backward-sun light absorption surface (12), comprising: an upright post (2) and a torque tube (3) disposed on the upright post, the torque tube (3) capable of being rotated around the upright post under the action of a driving device (4), a plurality of groups of crossbeams (5) disposed along a lengthwise direction of the torque tube (3), the double-sided PV module (1) disposed on each group of the crossbeams, a light-reflecting-panel support (6) disposed at the torque tube (3), and a light-reflecting panel (7) disposed on the light-reflecting-panel support, wherein the light-reflecting panel reflects sunlight onto the backward-sun light absorption surface (12), and an angle (α) between a plane where the light-reflecting panel (7) is located and a plane where the double-sided PV module is located is an acute angle.

2. The horizontal single-axis tracking photovoltaic support according to claim 1, wherein the light-reflecting-panel support (6) is substantially W-shaped, and light-reflecting panels (7) are disposed on two outer side portions (62) of the light-reflecting-panel support (6).

3. The horizontal single-axis tracking photovoltaic support according to claim 2, wherein the light-reflecting-panel support (6) comprises a support main body (61) and the two outer side portions (62) connected with the support main body (61), the support main body (61) is fixedly connected with the torque tube (3), and the two outer side portions (62) are rotatably connected with the support main body (61).

4. The horizontal single-axis tracking photovoltaic support according to claim 2, wherein light reflected on an outermost side of the light-reflecting panel (7) reaches an outer side end of the backward-sun light absorption surface (12), and light reflected on an innermost side of the light-reflecting panel (7) reaches an inner side end of the double-sided PV module backward-sun light absorption surface (12).

5. The horizontal single-axis tracking photovoltaic support according to claim 1, the angle α between the plane where the light-reflecting panel (7) is located and the plane where the double-sided PV module (2) is located ranges from 0° to 90°.

6. The horizontal single-axis tracking photovoltaic support according to claim 1, wherein the driving device (4) is a servo motor, a cylinder, or a hydro-cylinder, and the torque tube (3) is driven to be rotated by a power output end of the driving device (4).

7. The horizontal single-axis tracking photovoltaic support according to claim 1, wherein a surface of the light-reflecting panel (7) is a flat surface, a convex surface or a concave surface.
